(19) United States
(12) Patent Application Publication
(10) Pub. No.: US 2010/0281504 A1
(43) Pub. Date: Nov. 4, 2010

(54) AUTO-ZAPPING PROGRAMME FOR A DECODER FOR IDENTIFICATION OF A SELECTED TV EVENT USING DVB TECHNOLOGY AND MPEG ENCODING

(76) Inventor: Abdelhakim MEFTAHI, (US)

Correspondence Address: JEROME D. JACKSON (JACKSON PATENT LAW OFFICE), 211 N. UNION STREET, SUITE 100, ALEXANDRIA, VA, 22314, US

(21) Appl. No.: 12/600,317

(22) PCT Filed: Jul. 8, 2007
(86) PCT No.: PCT/DZ2007/000011

§ 371 Date: May 8, 2010

(30) Foreign Application Priority Data
May 20, 2007 (DZ) 070303

(51) Int. Cl. H04N 5/445

(52) U.S. Cl. 725/40

(57) ABSTRACT

The invention is of use to all television viewers who would like to watch a TV event in the near future, who fear missing said event due to forgetfulness or distraction when zapping through other programmes. By automatically zapping, the decoder places said TV event in the field of view of the viewer who has to do nothing. The aim of the invention is to provide a new DVB table with a supplementary service to those already on offer. This table is to inform the decoder of the beginning of each TV event on each channel which may be viewed using the same, whilst remaining tuned to one channel, such as to be able to compare the identity thereof with the event selected by the viewer at a previous moment with the goal of watching the same. At the start of a TV event, if the identity thereof is not recognised by the decoder the event is ignored. On the other hand where the event is recognised using the above comparison, the decoder starts the zapping to the channel broadcasting the event in an automatic manner. The viewer thus has no longer to fear missing the TV events he likes to watch, the task being left to the decoder such as a secretary manages the appointments of the boss.

### TECHNICAL FIELD TO WHICH THE INVENTION RELATES

The invention relates to the DVB (Digital Video Broadcasting) technology, and comprises the scheduled auto-zapping by a decoder based upon the identification of the selected TV event, by use of DVB technology and MPEG encoding. It affects the different areas of DVB:

DVB-S

DVB-C

DVB-T (TNT)

And in the near future, it can affect the DVB-H with the arrival of television on the portable.

This invention is beneficial to all television viewers that wish to view a televised event scheduled in the near future, and who have a concern of missing it out of forgetfulness or distraction during zapping of other programs. By automatically zapping, the decoder puts the TV event in question in the field of vision of the television viewer, without the latter lifting a finger.

### GOAL OF THE INVENTION

Given the exorbitant number of TV channels that we receive, and come to be offered to us without our paying a single penny, and given the interest they generate in us each in his area. We, the television generation, that live in this boom of channels, and that we were being accustomed to a number that does not exceed, only just a few years ago, the number of fingers of a single hand. We are in total disarray as to the management of these channels. Even if we limit ourselves to a list interesting to us, there is always something to see on another channel that is not part of our favorites. We all have had the disappointing experience to recall, too late, that we missed a program that we planned to view, and this experience continues to repeat itself given the growing number of broadcasted channels and program quality that does not cease to excel. To remedy this, and not miss any program or rebroadcast of program, I propose an invention whose goal comprises programming the decoder to automatically zap to the channel that broadcasts the TV event that the television viewer wishes to view, at the same time as the start of this event, by automatically recognizing the precise identity of the TV event selected by the means of DVB tables defined in the MPEG standard. This enables us total control of TV events that we select to view.

### STATE OF THE PRIOR ART

Since the conception of DVB in 1993, the services that it can offer in the field of control of television events are limited to those provided by the EIT tables (Event Information Table):

EIT Present/Following: PID 18 and table_id 78 and 79

EIT Schedule: PID 18 and table_id from 80 to 95 and from 96 to 111

These tables, between the two of them, provide data about the current events and the future events over a week, on the services of the multiplex of an operator; this enables composition of an EPG (Electronic Program Guide), that is to say an electronic guide of programs. But hereto nobody has used the DVB technology for to the ends that are the subject of this patent, and that comprises the precise and automatic recognition of the identity (unique) of a TV program event, and the use of this identity in the automatic execution of an order given, by the television viewer, at an earlier time in the case of zapping to the TV event in question, at the same time as the start of this event.

The DVB tables, “EIT present/following” and “EIT Schedule”, which provide data about the current events and those that follow and that are the basis for the composition of the EPG, enable the television viewer to be abreast of events of current and future TV programs, but, because of their passivity, they are not very useful against forgetting and missing of rebroadcasts of his favorite events. As for the table resulting from this invention, because of its active execution of a previously scheduled order, in the case zapping to a preselected event, from its spot announcement or from the EPG, represents a windfall for the television viewer in the face of the confusion that he experienced regarding the management of his TV programs, in an era where the number of channels does not cease to increase and the quality of broadcasts does not cease to excel.

### PRESENTATION OF THE ESSENCE (THE SUBSTANCE) OF THE INVENTION AND ITS IMPLEMENTATION MODE

DVB is a standard that relates to the signaling broadcasted transmitted in the stream (the DVB tables), which enables any DVB decoder to find the received programs. The various digital television channels are multiplexed. A TV program is composed of the stream of video component, the stream of the audio component, the stream of subtitles in French, the stream of subtitles in English . . . etc. Each of these streams is transported by transport packets that carry a common number for each of the streams; the Packet Identifier (PID). The DVB tables serve to determine what transports a stream of transport packets with a common PID. A common time reference enables synchronization between the elementary streams.

Our scheme comprises the development of a new DVB table providing an additional service to those already existing. This table is intended to inform the decoder of the start of each event of each channel receivable by the latter, while being tuned to a single channel, so it can compare its identity with those of the events entered by the television viewer, at an earlier time, in order to view them. Also, this table is intended to provide to the decoder the identity of the event or of the spot announcement of the event in progress on the screen throughout its broadcast, in order to enable the entry.

At the time of the start of a TV event, if the identity of the latter is not recognized by the decoder, the event is ignored. By contrast, in the case where it is recognized, by the comparison cited above, the decoder takes the step of automatically zapping to the TV channel broadcasting this event. Thus the television viewer will no longer worry about missing the TV events that he likes to view; this task will be left to the decoder. As a secretary that manages the appointments of his boss.

To do this, before the broadcast of programs, each TV event or event announcement must have an identity coded in a manner such that at the reception, at the decoder, each event or event announcement will be individually identified. This identity will be transported by the NEIT table (Network Event Identity table) that will comprise (will carry) the identity of each event of each program receivable by the decoder. The NEIT table will be part of the set of tables that comprise each program; in other words, the PMT (Program Map Table) of each program must comprise the PID of the NEIT in addition to the PIDs of other tables that constitute the program. The NEIT is unique for all the programs. For example, a TV program is composed of the stream of the video component, the stream of the audio component, the stream of subtitles in French, the stream of identities of events and event announcements, . . . etc.

Knowing that the decoder recognizes the packets associated with the identification corresponding to the selected program and ignores the others. And yet the selected program comprises among its tables the NEIT, which informs the decoder of the identity of events currently being broadcast and those that have just started. The decoder in its systematic operation of comparing the identity of each event that has just started with the identity of events that have been entered to be viewed. If one of these recently received events is identified as such, the decoder automatically zaps to the channel where this event is broadcasted.

Entry of a TV Event:

As we have just seen, in order for the decoder to be able to automatically zap at the appropriate time, beforehand the television viewer must enter the identity of the selected event into the decoder, by holding for three seconds the button of the remote controller reserved for this task. There are three ways to do this:

The television viewer can enter the identity of the selected TV event from the identity of the spot announcement of the same event, available to the decoder at the time of broadcast of the spot announcement.

The television viewer can enter the identity of the selected TV event during the broadcast of the same event in order that it be, subsequently, recognized and auto-zapped by the decoder at the start of a later rebroadcast.

The television viewer can enter the identity of the selected TV event from the descriptive box for the event, available on the electronic program guide (EPG).

It is important to note that two conditions are imposed concerning the identity of the event and that of the spot announcement of the same event:

The first condition is that the identity of the spot announcement of the event must contain the identity of the same event, in order to enable the entry of it.

The second condition is that the identity of spot announcement of the event must have a prefix that identifies it as the announcement of the event, and not the event itself.

It will be also necessary that the EPG, in addition to the data that it provides about the programs, also provide the identity code for each TV event, in order to enable the entry of it.

Definition of the NEIT Table

The NEIT table: (Network Event Identity Table) is a DVB table defined in the MPEG standard, which is intended to convey the identity of each TV event broadcasted or each event announcement. This identity is unique for each event or event announcement. It must also comprise the identity of the channel on which this event is broadcasted in order that the decoder is able to zap to the event.

Ergonomy:

For better ergonomy, the identity code of a TV event must indicate whether it relates to its first broadcast, first rebroadcast, second or third. For example, if a television viewer follows a TV series, and cannot be present at his home except after work at 18:00 and he sleeps at 23:00. In this case, he enters the rebroadcast of the TV series that plays in this time slot; for example if the second rebroadcast plays at 21:00, he enters only the latter, in order that the decoder zap only to the second rebroadcast, ignoring the other broadcasts.

The television viewer can enter the identity of the televised news of a given channel, so that the decoder can automatically zap it for him daily.

If the television viewer wishes to turn off his television while leaving the decoder on, the latter, by receiving the entered event identity, not only takes the step of zapping to the corresponding channel, but also, it takes a second step, that of turning the television monitor on.

1. Method of automatic zapping, in a television decoder, previously determined by the television viewer and saved in the memory of the decoder, to a television event scheduled and announced previously by any TV channel received by the same decoder. By use of the unique coded identity of a television event.

2. The method of claim 1, characterized in that each TV channel has a unique and definitive identity code specific to it.

3. The method according to claims 1 and 2, characterized in that the broadcast of all the television events of all the television channels is preceded by the allocation of each of these events with a unique identity code for each of them, taking into account the identity of the channel broadcasting each event.

4. Process according to claims 1, 2 and 3, characterized in that the identity code of a television channel is made so that it is a component of the identity code for the television event.

5. The method according to claims 1 to 4, characterized in that the identity codes of the broadcasted events, and receivable by a common decoder, are transported in the TS (Transport Stream).

6. The method according to claims 1 to 5, characterized in that the identity codes cited in claim 5 are transported in the TS, in a DVB table specially created for this task and that is one of the claims of this patent and that is named NEIT (Network Event Identity Table), at the same time as all the other tables of the program.

7. The method according to claim 6, characterized in that the new DVB table called NEIT that, like all the tables broadcasted repeatedly, each time transports the identity codes of events whose broadcast has just been started by all channels receivable by a common decoder in order to inform the latter of the arrival of the events on the other programs.

8. The method according claims 6 and 7, characterized in that the NEIT table is part of the set of tables constituting each program of the set of programs received by a common decoder.

9. The method according to claims 6, 7 and 8, characterized in that the NEIT table and its contents are the same for all the programs receivable by a common decoder in a given time.

10. The method according to claims 1 to 9, characterized in that the identity code of a television event is recordable in the memory of the decoder at the request of television viewer.

11. The method according to claims 1 to 10, characterized in that the identity code of a television event is recordable in an electronically programmable and erasable non-volatile protected memory.

12. The method according to claims 1 to 11, characterized in that the identity code of a television event is recordable in the memory of the decoder at the time of the broadcast of the spot announcement of the event in question or at the time of the broadcast of the event itself in order to be able to view a later broadcast of the same event or from the descriptive box of the event available on the EPG.

13. The method according to claims 1 to 12, characterized in that the identity codes carried in each NEIT table and received by the decoder are systematically compared to the identity codes recorded (saved) in the memory of the decoder.

14. The method of claim 13, characterized in that the identity code transported in the NEIT table and identified in the memory of the decoder is sent to the switcher.

15. The method according to claims 4 and 14, characterized in that the identity code received by the switcher constitutes in itself an order given to the latter to execute the action of zapping to the television channel whose identity is carried by this same code.

16. The method according to claims 1 to 15, characterized in that the method that is the subject of the patent is valid for digital television as well as for television on mobile phones (DVB-H) and the Internet.
